(19) United States
(12) Patent Application Publication
(10) Pub. No.: US 2021/0072165 A1
(43) Pub. Date: Mar. 11, 2021

(54) DEFECT DISPLAY DEVICE AND METHOD

(71) Applicant: FUJIFILM Corporation, Tokyo (JP)

(72) Inventor: Yasuhiko KANEKO, Tokyo (JP)

(73) Assignee: FUJIFILM Corporation, Tokyo (JP)

(21) Appl. No.: 17/099,912

(22) Filed: Nov. 17, 2020

Related U.S. Application Data
(63) Continuation of application No. PCT/JP2019/022148, filed on Jun. 4, 2019.

(30) Foreign Application Priority Data
Jun. 29, 2018 (JP) 2018-124903

(51) Int. Cl. G01N 23/04; G06T 7/00

(52) U.S. Cl. CPC G01N 23/04; G06T 2200/24; G06T 7/0004

(57) ABSTRACT

Provided are a defect display device and method capable of displaying a radiographic image of an industrial product (object) such as a casting so as to support the determination of the severity of the industrial product without interference with the interpretation of the radiographic image. The defect display device includes an image acquisition unit that acquires a radiographic image captured with radiation transmitted through an object, a defect information acquisition unit that acquires defect information indicating defects in the object detected from the radiographic image, a display unit that displays the radiographic image on a screen, an input unit that accepts an instruction input from a user, and a display control unit that generates, based on the defect information, a contour corresponding to a distribution of a plurality of defects among the defects in the object, displays the contour on the screen, and changes display of the contour in accordance with a generation condition of contour accepted through the input unit.

### CROSS-REFERENCE TO RELATED APPLICATIONS

The present application is a Continuation of PCT International Application No. PCT/JP2019/022148 filed on Jun. 4, 2019 claiming priority under 35 U.S.C. § 119(a) to Japanese Patent Application No. 2018-124903 filed on Jun. 29, 2018. Each of the above applications is hereby expressly incorporated by reference, in its entirety, into the present application.

### BACKGROUND OF THE INVENTION

### 1. Field of the Invention

The present invention relates to defect display devices and methods, and more specifically to a defect display device and method for supporting inspection of defects in industrial products such as castings.

### 2. Description of the Related Art

Examples of a method of inspecting defects in an industrial product such as a casting include nondestructive inspection involving irradiation of the industrial product with light or radiation. In the nondestructive inspection, an inspection-target industrial product is irradiated with light or radiation to obtain an image of the industrial product, and the image is interpreted by an image interpreter to inspect defects.

JP2004-034144A discloses an inspection support apparatus that uses an X-ray CT (Computed Tomography) scanner to capture CT tomographic images of a casting and that creates, from the CT tomographic image group, a polygon-surface model in which surfaces of the casting are represented by polygons (polygonal surface elements). In the inspection support apparatus described in JP2004-034144A, polygons on the outer surface are set to be semi-transparent, and polygons corresponding to internal defects are set to have a color easily distinguishable from the color of the polygons on the outer surface. According to the inspection support apparatus described in JP2004-034144A, internal defects of the casting, such as blowholes, are displayed so as to be clearly visible through a semi-transparent casting shape display.

### SUMMARY OF THE INVENTION

As in the inspection support apparatus described in JP2004-034144A, when polygons determined to be internal defects are displayed in color in a radiographic image (X-ray transmission image) of an inspection-target industrial product, the internal defects and their surrounding portions are difficult to see if the number of internal defects per unit area is large and the density of internal defects is high. Accordingly, there is a problem in that merely coloring polygons determined to be internal defects causes a difficulty in the interpretation of an image.

In addition, industrial products are different in shape depending on the type of industrial product, and the density of defects to be allowed differs depending on the portion of the industrial product or the defect type. Accordingly, even if an image of an industrial product includes a region with a high density of defects, the industrial product is not immediately determined to be unusable or determined to be a reject.

In JP2004-034144A, an image interpreter determines the severity of the inspection-target industrial product on the basis of an image including colored polygons corresponding to internal defects, and the determination of the severity of the inspection-target industrial product is left to the judgment of individual image interpreters. Accordingly, the determination of the severity can vary depending on the image interpreter. For example, if there is a portion with a high density of defects detected from an image, an image interpreter can possibly determine immediately that the industrial product is of high severity.

The present invention has been made in view of the foregoing situation, and an object thereof is to provide a defect display device and method capable of displaying a radiographic image of an industrial product (object) such as a casting so as to support the determination of the severity of the industrial product without interference with the interpretation of the radiographic image.

To address the problem described above, a defect display device according to a first aspect of the present invention includes an image acquisition unit that acquires a radiographic image captured with radiation transmitted through an object, a defect information acquisition unit that acquires defect information indicating defects in the object detected from the radiographic image, a display unit that displays the radiographic image on a screen, an input unit that accepts an instruction input from a user, and a display control unit that generates, based on the defect information, a contour corresponding to a distribution of a plurality of defects among the defects in the object, displays the contour on the screen, and changes display of the contour in accordance with a generation condition of the contour accepted through the input unit.

According to the first aspect, it is possible to display a contour corresponding to the distribution of defects without reducing the visibility of defects and their surrounding portions. According to the first aspect, furthermore, since the display style of the contour can be changed by changing a generation condition of the contour, it is possible to obtain information useful for determining the occurrence state of defects or the severity of the object.

A defect display device according to a second aspect of the present invention is the defect display device according to the first aspect, in which the input unit accepts, as the generation condition of the contour, an input of a numerical value indicating an interval between the plurality of defects, and the display control unit displays, on the screen, a contour corresponding to a shape of a distribution of defects between which the interval is less than the numerical value among the plurality of defects.

According to the second aspect, the display of the contour is changed in accordance with an input of a numerical value indicating an interval between defects, thereby making it possible to obtain information useful for determining the occurrence state of defects or the severity of the object.

A defect display device according to a third aspect of the present invention is the defect display device according to the first aspect, in which the input unit accepts, as the generation condition of the contour, an input of a plurality of numerical values indicating an interval between the plurality of defects, and the display control unit displays, on the screen, a plurality of contours each corresponding to a shape of a distribution of defects between which the interval is less than a corresponding one of the plurality of numerical values among the plurality of defects.

According to the third aspect, the display of the plurality of contours is changed in accordance with an input of a numerical value indicating an interval between defects, thereby making it possible to obtain information useful for determining the occurrence state of defects or the severity of the object.

A defect display device according to a fourth aspect of the present invention is the defect display device according to the third aspect, in which the display control unit displays the plurality of contours on the screen in a distinguishable manner.

A defect display device according to a fifth aspect of the present invention is the defect display device according to the fourth aspect, in which the display control unit displays a slider bar on the screen, the slider bar including a plurality of sliders for accepting an input of the plurality of numerical values, and displays a correspondence between the plurality of contours and the plurality of sliders on the screen in a distinguishable manner.

A defect display device according to a sixth aspect of the present invention is the defect display device according to the fifth aspect, in which the display control unit displays the plurality of contours and the plurality of sliders on the screen in a distinguishable manner by using at least one of a color, a line thickness, or a line type of the contours and the plurality of sliders.

According to the fourth to sixth aspects, even if a plurality of contours are present, the relationship between the contours and the density of defects is easy to recognize visually.

A defect display device according to a seventh aspect of the present invention is the defect display device according to any one of the first to sixth aspects, in which the input unit accepts, as the generation condition of the contour, an input of a numerical value indicating dimensions of the defects, and the display control unit displays, on the screen, a contour corresponding to a shape of a distribution of defects corresponding to the dimensions input via the input unit among the plurality of defects.

According to the seventh aspect, for example, it is possible to display a contour in a region where defects having a large size are concentrated. Accordingly, it is possible to obtain information useful for determining the occurrence state of defects or the severity of the object.

A defect display device according to an eighth aspect of the present invention is the defect display device according to any one of the first to seventh aspects, in which the input unit accepts, as the generation condition of the contour, an input of a numerical value indicating a thickness of the object, and the display control unit selects defects positioned in a portion of the object corresponding to the thickness input via the input unit among the plurality of defects, and generates the contour for the selected defects.

According to the eighth aspect, for example, it is possible to display a contour in a portion having a thin thickness and having a high density of defects and not to display a contour in a portion having a density of defects but having a thick thickness and having a relatively low effect on the quality of the object. Accordingly, it is possible to obtain information useful for determining the occurrence state of defects or the severity of the object.

A defect display device according to a ninth aspect of the present invention is the defect display device according to any one of the first to eighth aspects, in which the input unit causes the display unit to display information indicating a frequency of detection of the defects for each feature value, and accepts, as the generation condition of the contour, a designation of the feature value, and the display control unit selects defects corresponding to the designated feature value among the plurality of defects, and generates the contour for the selected defects.

A defect display device according to a tenth aspect of the present invention is the defect display device according to the ninth aspect, in which the input unit causes the display unit to display information indicating the frequency of detection of the defects for at least one feature value among the number of defects, a density of the defects, an interval between the defects, dimensions of the defects, or a thickness of the object at a position where the defects are detected.

According to the ninth and tenth aspects, for example, it is possible to obtain information useful for determining the occurrence state of defects or the severity of the object, such as the detection of a large number of defects in a location having a thin thickness in accordance with the relationship between the feature value and the frequency of detection.

In any of the first to tenth aspects, the inspection-target defects and the plurality of defects may have a bubble-like shape.

A defect display method according to an eleventh aspect of the present invention includes a step of acquiring a radiographic image captured with radiation transmitted through an object, a step of acquiring defect information indicating defects in the object detected from the radiographic image, a step of displaying the radiographic image on a screen, and a step of generating, based on the defect information, a contour corresponding to a distribution of a plurality of defects among the defects in the object, displaying the contour on the screen, and changing display of the contour in accordance with a generation condition of the contour accepted from a user through an input unit.

According to the present invention, it is possible to display a contour corresponding to the distribution of defects without reducing the visibility of defects and their surrounding portions. According to the present invention, furthermore, since the display style of the contour can be changed by changing a generation condition of the contour, it is possible to obtain information useful for determining the occurrence state of defects or the severity of the object.

### BRIEF DESCRIPTION OF THE DRAWINGS

FIG. 1 is a block diagram illustrating a defect inspection device according to an embodiment of the present invention;

FIG. 2 is a data block diagram illustrating an example of defect information;

FIG. 3 is a block diagram illustrating an example of an imaging system;

FIG. 4 is a diagram illustrating a first example display of defects;

FIG. 5 is a diagram illustrating a second example display of defects; and

FIG. 6 is a flowchart illustrating a defect display method according to an embodiment of the present invention.

### DESCRIPTION OF THE PREFERRED EMBODIMENTS

The following describes an embodiment of a defect display device and method according to the present invention with reference to the accompanying drawings.

### Defect Inspection Device

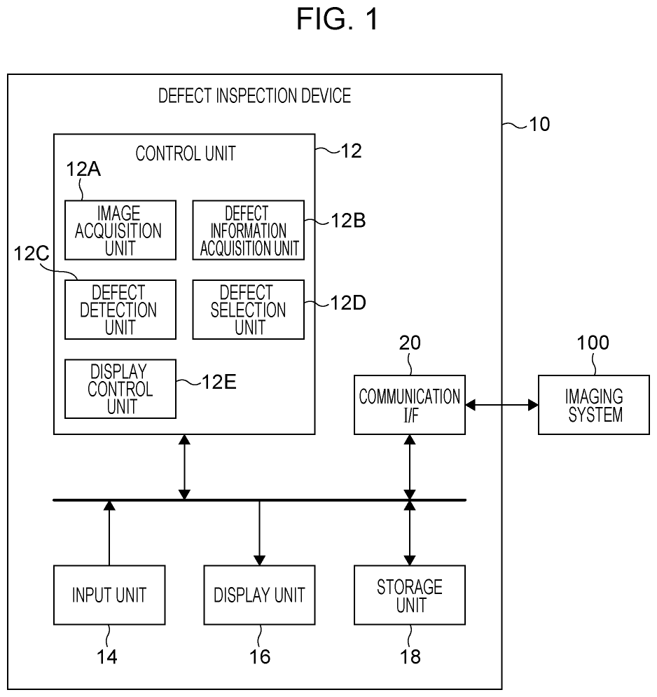

FIG. 1 is a block diagram illustrating a defect inspection device according to an embodiment of the present invention.

A defect inspection device 10 according to this embodiment is a device with which a user (image interpreter) performs nondestructive inspection of an industrial product such as a casting by using a radiographic image of the industrial product. The inspection-target industrial product is hereinafter referred to as an object OBJ.

As illustrated in FIG. 1, the defect inspection device 10 according to this embodiment includes a control unit 12, an input unit 14, a display unit 16, a storage unit 18, and a communication interface (communication I/F) 20. The defect inspection device 10 may be, for example, a personal computer or a workstation.

The control unit 12 includes a CPU (Central Processing Unit) that controls the operation of the components of the defect inspection device 10. The control unit 12 is capable of transmitting and receiving control signals and data to and from the components of the defect inspection device 10 via a bus. The control unit 12 accepts an instruction input from the user via the input unit 14 and transmits a control signal corresponding to the instruction input to the components of the defect inspection device 10 via the bus to control the operation of the components.

The control unit 12 includes an EEPROM (Electronically Erasable and Programmable Read Only Memory) that stores data including control programs or the like for various computations, a RAM (Random Access Memory) used as a work area for various computations, and a VRAM (Video Random Access Memory) used as an area to temporarily store image data to be output to the display unit 16.

The input unit 14 is an input device that accepts an instruction input from the user, and includes a keyboard for text input and the like, and a pointing device (for example, a mouse, a trackball, or the like) for operating a GUI (Graphical User Interface) such as a pointer and an icon displayed on the display unit 16. Instead of the keyboard and the pointing device or in addition to the keyboard and the pointing device, a touch panel disposed on a surface of the display unit 16 may be used as the input unit 14.

The display unit 16 is a device for displaying an image. For example, a liquid crystal monitor may be used as the display unit 16.

The storage unit 18 stores various data including a radiographic image (for example, an X-ray transmission image) of the object OBJ, which is acquired from an imaging system 100. As the storage unit 18, for example, a device including a magnetic disk such as an HDD (Hard Disk Drive), a device including a flash memory such as an eMMC (embedded Multi Media Card) or an SSD (Solid State Drive), or the like may be used.

The communication I/F 20 is means for communicating with an external device via a network. As a method for transmitting and receiving data between the defect inspection device 10 and an external device, wired communication or wireless communication (for example, a LAN (Local Area Network), a WAN (Wide Area Network), Internet connection, or the like) may be used.

The defect inspection device 10 is capable of accepting an input of a radiographic image from the imaging system 100 via the communication I/F 20. The method for inputting a radiographic image to the defect inspection device 10 is not limited to communication via a network. For example, a USB (Universal Serial Bus) cable, Bluetooth (registered trademark), infrared communication, or the like may be used. Alternatively, a recording medium (for example, a memory card) removably attachable to and readable by the defect inspection device 10 may store a radiographic image, and an input of the radiographic image may be accepted via the recording medium.

Next, the defect detection and display function of the defect inspection device will be described. As illustrated in FIG. 1, the control unit 12 includes an image acquisition unit 12A, a defect detection unit 12C, a defect information acquisition unit 12B, a defect selection unit 12D, and a display control unit 12E.

First, for defect detection, the image acquisition unit 12A acquires a radiographic image (for example, an X-ray transmission image) of the object OBJ from the imaging system 100 or the like.

The defect detection unit 12C analyzes the radiographic image of the object OBJ, checks the radiographic image against design data (for example, CAD (Computer-Aided Design) data) of the object OBJ, and detects defects included in the object OBJ.

Defects occurring in industrial products such as castings can be classified according to the shape and cause. Examples of the type of defect occurring in industrial products such as castings include stains, cracks, chipping, defects caused by contamination with foreign substances and dissimilar kinds of metals, and bubble-like defects caused by contamination of a mold with air during casting.

The defect detection unit 12C identifies the type of defect on the basis of the size and shape of defects detected by image analysis, and the luminance differences between the defect and neighboring pixels, which are caused by the transmittance and scattering of radiation through the object OBJ. Then, the defect detection unit 12C assigns an identifier for identifying defects and generates defect information DAT1 in association with information on the type of defect. The defect detection unit 12C generates the defect information DAT1 for each defect and stores the defect information DAT1 in the storage unit 18 in association with the radiographic image.

For example, the defect information DAT1 may be stored as accessory information or header information of an image file of the radiographic image, or may be stored in the storage unit 18 as a file separate from the image file of the radiographic image.

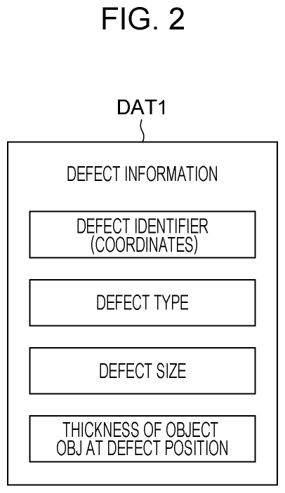

FIG. 2 is a data block diagram illustrating an example of the defect information DAT1. As illustrated in FIG. 2, the defect information DAT1 includes information on the defect identifier, the defect type and size, and the thickness of the object OBJ at the position of defects.

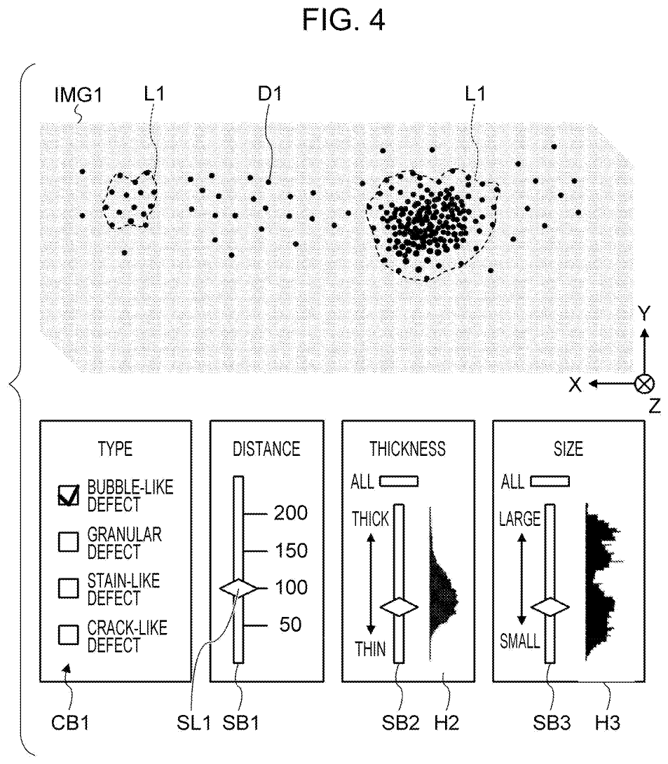

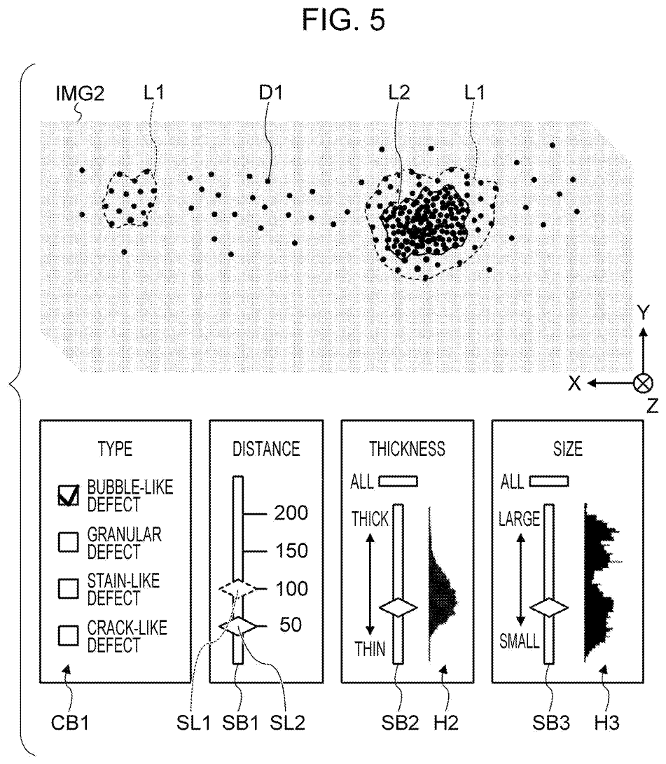

As the defect identifier, a symbol or number unique to each defect may be assigned. Alternatively, for example, two-dimensional coordinates (coordinates (X, Y), see FIG. 4 and FIG. 5) indicating the position (for example, the position of the center of gravity) of the defect in the radiographic image may be used as the identifier.

The defect type is, for example, information indicating a type of defect such as a bubble-like defect, a granular defect, a stain-like defect, or a crack-like defect.

The defect size is, for example, information indicating the maximum dimensions, the minimum dimensions, or the area of a defect. As the defect size, the dimensions of a defect in the radiographic image along the coordinate axes (X, Y), the average value of the maximum dimensions and the minimum dimensions of defects, or the average value of the dimensions of defects along the coordinate axes may be used.

To evaluate the possible influence of defects on the object OBJ, the information on the defect size preferably includes information on the maximum dimensions of defects.

As the information on the thickness of the object OBJ at the position of defects, information indicating the thickness of the object OBJ at the position of defects in the design data, rather than the thickness of the object OBJ in the transmission direction of radiation through the object OBJ (hereinafter referred to as the Z direction. See FIG. 4 and FIG. 5), is used.

To evaluate the possible influence of defects on the object OBJ, the information on the thickness of the object OBJ at the position of defects preferably includes information on the minimum value of the thickness.

Then, to display defects, the image acquisition unit 12A acquires a radiographic image of the object OBJ from the storage unit 18, and the defect information acquisition unit 12B acquires the defect information DAT1 associated with the radiographic image of the object OBJ.

The defect selection unit 12D selects defects in accordance with an instruction input from the input unit 14. The defect selection unit 12D accepts, for example, an input of selection criteria such as the defect type or size, or the thickness of the object OBJ at the position of defects, and the density of neighboring defects. Then, the defect selection unit 12D selects defects that match the selection criteria on the basis of the defect information DAT1 (see FIG. 4 and FIG. 5).

When displaying the radiographic image on the display unit 16, the display control unit 12E performs image processing, such as data conversion and size and luminance adjustment, on the radiographic image and generates a radiographic image for display. The display control unit 12E generates a contour corresponding to the distribution of the defects selected by the defect selection unit 12D and causes the display unit 16 to superimpose and display the contour on the display radiographic image.

### Imaging System

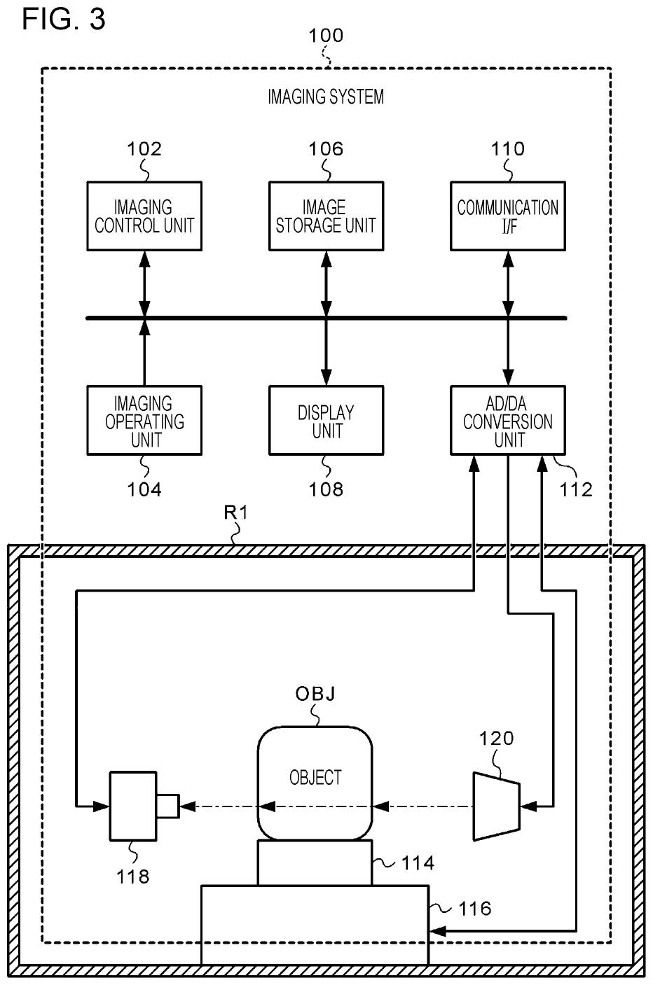

Next, the imaging system 100 for capturing an image of the object OBJ will be described with reference to FIG. 3. FIG. 3 is a block diagram illustrating an example of the imaging system 100.

The imaging system 100 is used to capture an image of an inspection-target industrial product in an imaging room R1.

As illustrated in FIG. 3, the imaging system 100 includes an imaging control unit 102, an imaging operating unit 104, an image storage unit 106, a display unit 108, a communication interface (communication I/F) 110, an AD/DA (analog to digital/digital to analog) conversion unit 112, a stage 114, a stage driving unit 116, a camera 118, and a radiation source 120. The imaging control unit 102, the imaging operating unit 104, the image storage unit 106, the display unit 108, the communication I/F 110, and the AD/DA conversion unit 112 may be included in a personal computer or a workstation.

The imaging control unit 102 includes a CPU that controls the operation of the components of the imaging system 100, and is connected to the components of the imaging system 100 via a bus. The imaging control unit 102 accepts an instruction input from the user (a person who performs imaging) via the imaging operating unit 104 and transmits a control signal corresponding to the instruction input to the components of the imaging system 100 to control the operation of the components.

The imaging operating unit 104 is an input device that accepts an instruction input from the user, and includes a keyboard for text input, and a pointing device (for example, a mouse, a trackball, or the like) for operating a pointer, an icon, and the like displayed on the display unit 108. The user is able to input information on the object OBJ, input an instruction for instructing the camera 118 to perform imaging (including the setting of, for example, imaging conditions such as the exposure time, the focal length, and the aperture, the imaging angle, the imaging location, and so on), input an instruction for instructing the radiation source 120 to irradiate the object OBJ with radiation (including the setting of, for example, the irradiation start time, the irradiation duration, the irradiation angle, the irradiation intensity, and so on), and input an instruction to store the acquired image data in the image storage unit 106, through the imaging operating unit 104.

The image storage unit 106 stores an image of the object OBJ, which is captured by the camera 118. As the image storage unit 106, for example, a device including a magnetic disk such as an HDD, a device including a flash memory such as an eMMC or an SSD, or the like may be used. The image storage unit 106 stores information for identifying the object OBJ in association with the image data.

The display unit 108 is a device for displaying an image. For example, a liquid crystal monitor may be used as the display unit 108.

The communication I/F 110 is means for communicating with an external device via a network or the like. The image of the object OBJ, which is captured in the imaging system 100, can be transferred to the defect inspection device 10 via the communication I/F 110.

The AD/DA conversion unit 112 converts a digital control signal output from the imaging control unit 102 into an analog signal and transmits the analog signal to the components located in the imaging room R1, for example, the stage driving unit 116 and the radiation source 120.

The AD/DA conversion unit 112 converts an analog signal output from each of the components located in the imaging room R1 (for example, a signal indicating the position of the stage 114, which is detected by the stage driving unit 116) into a digital signal and transmits the digital signal to the imaging control unit 102. The imaging control unit 102 is capable of causing the display unit 108 to display, for example, the movable range of the stage 114 based on the signal indicating the position of the stage 114.

The camera 118 and the radiation source 120 are disposed in the imaging room R1. The radiation source 120 is, for example, an X-ray source, and a partition wall between the imaging room R1 and the outside and the entrance are made of an X-ray protective material (such as, lead or concrete) and is X-ray protected. Here, the radiation source 120 is not limited to an X-ray source. For example, the radiation source 120 may be a gamma-ray source configured to capture a gamma-ray transmission image.

The radiation source 120 irradiates the object OBJ placed on the stage 114 in the imaging room R1 with radiation in accordance with an instruction from the imaging control unit 102.

In accordance with an instruction from the imaging control unit 102 to perform imaging, the camera 118 receives radiation emitted from the radiation source 120 to the object OBJ and transmitted through the object OBJ, and captures an image of the object OBJ.

The object OBJ is placed on the stage 114. The stage driving unit 116 includes an actuator, a motor, or the like for moving the stage 114, and is capable of moving the stage 114. The camera 118 and the radiation source 120 are attached so as to be movable in the imaging room R1. The user is able to control the relative positions, distances, and angles of the object OBJ, the camera 118, and the radiation source 120 via the imaging control unit 102, and is able to capture an image of any portion of the object OBJ from any direction.

The radiation source 120 terminates the irradiation of the object OBJ with radiation in synchronization with the termination of the imaging operation performed by the camera 118.

In the example illustrated in FIG. 3, the camera 118 is disposed in the imaging room R1. Alternatively, the camera 118 may be disposed outside the imaging room R1.

In the example illustrated in FIG. 3, furthermore, a single camera 118 and a single radiation source 120 are disposed. However, the number of cameras and the number of radiation sources are not limited to one.

In the example illustrated in FIG. 3, imaging is performed with the object OBJ placed on the stage 114 in the imaging room R1. However, the present invention is not limited to this. If it is difficult to transport the object OBJ into the imaging room R1, the user may capture an X-ray transmission image of the object OBJ by using a transportable portable X-ray nondestructive inspection device including an X-ray generation device and an X-ray imaging device.

### Example Display of Defects

Next, an example display of defects by using the defect inspection device 10 will be described with reference to FIG. 4 and FIG. 5.

In an example illustrated in FIG. 4, a radiographic image IMG1 and a GUI for controlling the display of the radiographic image IMG1 are displayed on the screen of the display unit 16. In FIG. 4, a defect in the radiographic image IMG1 is indicated by a symbol D1.

The GUI illustrated in FIG. 4 is an operating member for allowing the defect selection unit 12D to accept an input of defect selection criteria, that is, generation conditions of a contour L1.

A checkbox CB1 is an operating member for accepting designation of a defect type. In the example illustrated in FIG. 4, a bubble-like defect, a granular defect, a stain-like defect, and a crack-like defect are selectable as defect types. In the example illustrated in FIG. 4, only the bubble-like defect is selected as the defect type. However, a plurality of types can be designated.

A slider bar SB1 is an operating member for designating the distance (interval) between the defects D1. A slider SL1 can be moved along the slider bar SB1 by using the pointing device of the input unit 14, and the interval is designated by the position of the slider SL1. The interval between the defects D1 may be designated by a direct numerical value.

The defect selection unit 12D selects defects D1 between which the interval on the XY plane of the radiographic image IMG1 is less than or equal to an interval designated by using the slider bar SB1. As the interval between the defects D1, for example, the interval between the centers of gravity of the defects may be used, or the interval between the outer edges of the defects may be used. In the example illustrated in FIG. 4, the slider SL1 is in the position of 100 micrometers. Thus, defects D1 having an interval less than or equal to 100 micrometers are selected.

In accordance with the distribution of the defects D1 selected by the defect selection unit 12D in the radiographic image IMG1, the display control unit 12E generates a contour L1 surrounding the defects D1 and causes the contour L1 to be displayed superimposed on the radiographic image IMG1. In the example illustrated in FIG. 4, contours L1 surrounding the defects D1 having an interval less than or equal to 100 micrometers are illustrated. The user can change the display of the contours L1 by moving the slider SL1. Accordingly, a region with a high density of defects D1 can be presented without reducing the visibility of the defects D1 and the surrounding portions.

A slider bar SB2 is an operating member for accepting designation of the thickness. A slider can be moved along the slider bar SB2 by using the pointing device of the input unit 14, and the thickness is designated by the position of the slider. When the slider is in “all” position, all the defects D1 are targets to be selected regardless of the thickness. The thickness may be designated by a numerical value.

A histogram H2 indicates the distribution of the frequency of detection of defects for each thickness of the object OBJ. The histogram H2 enables the user to, for example, obtain information useful for determining the occurrence state of the defects D1 or the severity of the object OBJ, such as the detection of a large number of defects D1 in a location having a thin thickness.

Upon acceptance of the designation of the thickness by using the slider bar SB2, the defect selection unit 12D selects, based on the defect information DAT1, defects D1 having an interval less than or equal to the interval designated by using the slider bar SB1 and positioned in a portion having a thickness less than or equal to the thickness designated by using the slider bar SB2.

In accordance with the distribution of the defects D1 selected by the defect selection unit 12D in the radiographic image IMG1, the display control unit 12E generates a contour L1 surrounding the defects D1 and causes the contour L1 to be displayed superimposed on the radiographic image IMG1. In the example illustrated in FIG. 4, contours L1 surrounding the defects D1 having an interval less than or equal to 100 micrometers and located at positions having thicknesses less than or equal to the thickness designated by using the slider bar SB2 are displayed. Accordingly, for example, it is possible to display the contour L1 in a portion with a high density of defects D1 located in a portion having a thin thickness and not to display the contour L1 in a portion having a high density of defects D1 but having a thick thickness and having a relatively low effect on the quality of the object OBJ.

A slider bar SB3 is an operating member for accepting designation of the size (dimensions) of defects. A slider can be moved along the slider bar SB3 by using the pointing device of the input unit 14, and the size of the defects D1 is designated by the position of the slider. When the slider is in “all” position, all the defects D1 are targets to be selected regardless of the size. The size of defects D1 may be designated by a numerical value.

A histogram H3 indicates the distribution of the frequency of detection of defects D1 for each size. The histogram H3 enables the user to obtain information useful for determining the occurrence state of the defects D1 or the severity of the object OBJ, such as the detection of a large number of defects D1 having a large size.

Upon acceptance of the designation of the size of the defects D1 by using the slider bar SB3, the defect selection unit 12D selects, based on the defect information DAT1, defects D1 having an interval less than or equal to the interval designated by using the slider bar SB1 and having sizes greater than or equal to the size designated by using the slider bar SB3.

In accordance with the distribution of the defects D1 selected by the defect selection unit 12D in the radiographic image IMG1, the display control unit 12E generates a contour L1 surrounding the defects D1 and causes the contour L1 to be displayed superimposed on the radiographic image IMG1. In the example illustrated in FIG. 4, contours L1 surrounding defects D1 having an interval less than or equal to 100 micrometers and having sizes greater than or equal to the size designated by using the slider bar SB3 are displayed. Accordingly, for example, the contour L1 can be displayed in a region with a high density of defects D1 having a large size.

In an example illustrated in FIG. 5, the slider bar SB1 for designating the interval is provided with two sliders SL1 and SL2. Three or more sliders may be provided.

The display control unit 12E causes contours L1 and L2 respectively corresponding to the two sliders SL1 and SL2 to be displayed superimposed on a radiographic image IMG2. In the example illustrated in FIG. 5, the contours L1 surrounding the defects D1 having an interval less than or equal to 100 micrometers and the contour L2 surrounding the defects D1 having an interval less than or equal to 50 micrometers are displayed superimposed on the radiographic image IMG2.

The sliders SL1 and SL2 and the contours L1 and L2 may be displayed in a distinguishable manner by, for example, making the color or the line thickness or type of the slider SL1 and the contour L1 identical and making the color or the line thickness or type of the slider SL2 and the contour L2 identical. In the example illustrated in FIG. 5, the slider SL1 and the contours L1 are depicted by broken lines, and the slider SL2 and the contour L2 are depicted by solid lines.

According to the example illustrated in FIG. 5, a plurality of contours can be displayed in accordance with the density of defects D1 in the object OBJ. This allows the user to obtain information useful for determining the occurrence state of the defects D1 or the severity of the object OBJ on the basis of the positions, number, and distribution of the plurality of contours.

In the examples illustrated in FIG. 4 and FIG. 5, a GUI is provided for individually designating the feature values for the defects D1 (the interval between the defects D1, the size of the defects D1, and the thickness of a portion where the defects D1 are present). These feature values may be set in accordance with, for example, the designation of the interval between the defects D1. In addition, the range of the values of the thickness and the size that can be designated may be limited in accordance with the interval between the defects D1. In addition, the feature values for the defects D1 may be automatically designated in accordance with the type of the object OBJ.

In the examples illustrated in FIG. 4 and FIG. 5, furthermore, the defect type, interval, and size, and the thickness of the object OBJ at the position where defects are detected can be designated as generation conditions of a contour, although the present invention is not limited to this. Other feature values for the defects D1, such as the number of defects, the density of defects (for example, the number of defects per unit area or the area occupied by defects per unit area), and the defect shape (for example, circular, elliptic, or rod shape), may be designated.

According to this embodiment, furthermore, the distribution of defects D1 can be interpreted in a plurality of radiographic images obtained by transmitting radiation through the object OBJ from a plurality of directions. This enables the inspection of defects based on three-dimensional distribution of defects D1.

### Defect Display Method

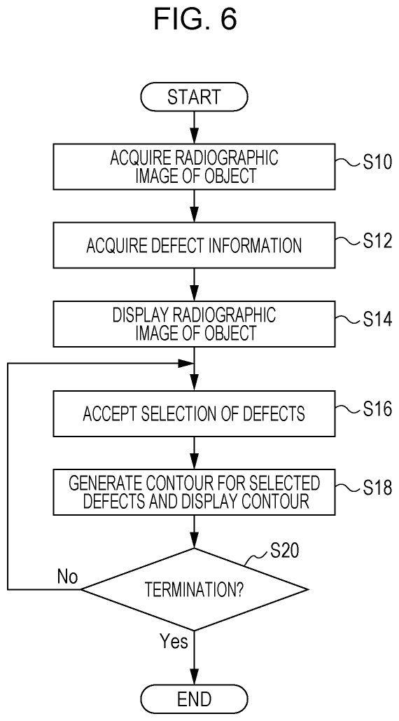

Next, a defect display method according to this embodiment will be described with reference to FIG. 6. FIG. 6 is a flowchart illustrating a defect display method according to an embodiment of the present invention.

First, the image acquisition unit 12A acquires a radiographic image of the object OBJ from the storage unit 18 (step S10). Then, the defect information acquisition unit 12B acquires the defect information DAT1 associated with the radiographic image acquired in step S10 from the storage unit 18 (step S12).

The display control unit 12E performs image processing, such as data conversion, on the radiographic image acquired in step S10 to generate a radiographic image for display, and causes the display unit 16 to display the radiographic image (step S14).

Then, the defect selection unit 12D causes the display unit 16 to display a GUI for selecting defects D1 (see FIG. 4 and FIG. 5) and accepts an instruction input related to the selection of defects D1 (step S16).

Then, the defect selection unit 12D selects defects D1 in accordance with the selection criteria of the defects D1, which are designated by the instruction input related to the selection of defects D1. Then, the display control unit 12E generates a contour corresponding to the shape of the distribution of the defects D1 selected by the defect selection unit 12D, and causes the display unit 16 to superimpose and display the contour on the radiographic image (step S18).

Then, steps S16 and S18 are repeatedly performed until a termination instruction is input from the input unit 14 (Yes in step S20). Accordingly, the user can interpret the image of the defects D1 while changing the display style of the contour by changing the selection criteria of the defects D1, that is, changing the generation conditions of the contour.

While this embodiment provides a description of the defect inspection device 10 having a function of analyzing a radiographic image of the object OBJ and detecting defects (the defect detection unit 12C), the present invention is not limited to this. The defect display device and method according to this embodiment can also be applied to a display device that does not have the defect detection unit 12C so long as the display device is capable of acquiring a radiographic image of the object OBJ and the defect information DAT1 and performing processing presented in this embodiment.

In addition, the defect display device and method according to this embodiment can also be applied to, for example, display control in the display unit 108 of the imaging system 100 or display control in a display unit disposed in a portable X-ray nondestructive inspection device.

The range of application of each embodiment of the present invention is not limited to defect inspection using a captured image of the object OBJ. This embodiment can also be applied to, for example, inspection of defects in coating applied to a motor vehicle or the like, and automatic defect classification (ADC) using a SEM (Scanning Electron Microscope) image, which is performed in a semiconductor manufacturing process.

The present invention can be implemented as a program for causing a computer to implement the processing described above, or a non-transitory recording medium or a program product storing such a program. Applying such a program to a computer enables computing means, recording means, and the like of the computer to implement the functions corresponding to the steps of the defect display method according to this embodiment.

In each embodiment, for example, the hardware structure of a processing unit that performs various processes can be implemented as various processors described below. The various processors include a CPU (Central Processing Unit) that is a general-purpose processor executing software (program) to function as various processing units, a Programmable Logic Device (PLD) that is a processor whose circuit configuration can be changed after manufacturing, such as an FPGA (Field Programmable Gate Array), a dedicated electric circuit that is a processor having a circuit configuration designed specifically for executing specific processing, such as an ASIC (Application Specific Integrated Circuit).

A single processing unit may be constituted by one of the various processors, or may be constituted by two or more processors of the same type or different types (for example, a plurality of FPGAs or a combination of a CPU and an FPGA). Alternatively, a plurality of processing units may be configured as a single processor. In examples of configuring a plurality of processing units as a single processor, first, as typified by a computer such as a client or a server, one or more CPUs and software are combined to configure a single processor, and the processor functions as the plurality of processing units. In the examples, second, as typified by a system on chip (SoC) or the like, a processor is used in which the functions of the entire system including the plurality of processing units are implemented as a single IC (Integrated Circuit) chip. In this way, the various processing units are configured by using one or more of the various processors described above as a hardware structure.

More specifically, the hardware structure of these various processors is an electric circuit (circuitry) in which circuit elements such as semiconductor elements are combined.

### REFERENCE SIGNS LIST

10 defect inspection device

12 control unit

14 input unit

16 display unit

18 storage unit

20 communication interface (communication I/F)

12A image acquisition unit

12B defect information acquisition unit

12C defect detection unit

12D defect selection unit

12E display control unit

DAT1 defect information

100 imaging system

102 imaging control unit

104 imaging operating unit

106 image storage unit

108 display unit

110 communication interface (communication I/F)

112 AD/DA conversion unit

114 stage

116 stage driving unit

118 camera

120 radiation source

OBJ object

IMG1, IMG2 radiographic image

D1 defect

L1, L2 contour

CB1 checkbox

SB1, SB2, SB3 slider bar

SL1, SL2 slider

H2, H3 histogram

S10 to S20 steps of defect display method

What is claimed is:

1. A defect display device comprising:
a monitor having a screen;
a user interface configured to accept an instruction input from a user; and
at least one processor configured to:
acquire a radiographic image captured with radiation transmitted through an object;
acquire defect information indicating defects in the object detected from the radiographic image;
generate, based on the defect information, a contour corresponding to a distribution of a plurality of defects among the defects in the object;
cause the contour to be displayed on the screen; and
change display of the contour in accordance with a generation condition of the contour accepted through the user interface.

2. The defect display device according to claim 1,
wherein the user interface accepts, as the generation condition of the contour, an input of a numerical value indicating an interval between the plurality of defects, and
wherein the at least one processor causes the monitor to display on the screen, a contour corresponding to a shape of a distribution of defects between which the interval is less than the numerical value among the plurality of defects.

3. The defect display device according to claim 1,
wherein the user interface accepts, as the generation condition of the contour, an input of a plurality of numerical values indicating an interval between the plurality of defects, and
wherein the at least one processor causes the monitor to display on the screen, a plurality of contours each corresponding to a shape of a distribution of defects between which the interval is less than a corresponding one of the plurality of numerical values among the plurality of defects.

4. The defect display device according to claim 3,
wherein the at least one processor causes the monitor to display the plurality of contours on the screen in a distinguishable manner.

5. The defect display device according to claim 4,
wherein the at least one processor causes the monitor to display a slider bar on the screen, the slider bar including a plurality of sliders for accepting an input of the plurality of numerical values, and causes the monitor to display a correspondence between the plurality of contours and the plurality of sliders on the screen in a distinguishable manner.

6. The defect display device according to claim 5,
wherein the at least one processor causes the monitor to display the plurality of contours and the plurality of sliders on the screen in a distinguishable manner by using at least one of a color, a line thickness, or a line type of the contours and the plurality of sliders.

7. The defect display device according to claim 1,
wherein the user interface accepts, as the generation condition of the contour, an input of a numerical value indicating dimensions of the defects, and
wherein the at least one processor causes the monitor to display, on the screen, a contour corresponding to a shape of a distribution of defects corresponding to the dimensions input via the user interface among the plurality of defects.

8. The defect display device according to claim 1,
wherein the user interface accepts, as the generation condition of the contour, an input of a numerical value indicating a thickness of the object, and
wherein the at least one processor selects defects positioned in a portion of the object corresponding to the thickness input via the user interface among the plurality of defects, and generates the contour for the selected defects.

9. The defect display device according to claim 1,
wherein the user interface causes the monitor to display information indicating a frequency of detection of the defects for each feature value, and accepts, as the generation condition of the contour, a designation of the feature value, and
wherein the at least one processor selects defects corresponding to the designated feature value among the plurality of defects, and generates the contour for the selected defects.

10. The defect display device according to claim 9,
wherein the user interface causes the monitor to display information indicating the frequency of detection of the defects for at least one feature value among the number of defects, a density of the defects, an interval between the defects, dimensions of the defects, or a thickness of the object at a position where the defects are detected.

11. The defect display device according to claim 1,
wherein the defects have a bubble-like shape.

12. A defect display method comprising:
acquiring a radiographic image captured with radiation transmitted through an object;
acquiring defect information indicating defects in the object detected from the radiographic image;
causing the radiographic image to be displayed on a screen; and
generating, based on the defect information, a contour corresponding to a distribution of a plurality of defects among the defects in the object, causing the contour to be displayed on the screen, and changing display of the contour in accordance with a generation condition of the contour accepted from a user through a user interface.

13. A defect display device comprising:
a monitor having a screen;
a user interface configured to accept an instruction input from a user; and
at least one processor configured to:
acquire a radiographic image captured with radiation transmitted through an object;
acquire defect information indicating defects in the object detected from the radiographic image;
select defects that match specific criteria from the detected defects based on the defect information;
generate a contour surrounding the selected defects;
cause the contour to be displayed on the screen; and
change display of the contour in accordance with a generation condition of the contour accepted through the user interface.
